(19) United States
(12) Patent Application Publication
(10) Pub. No.: US 2021/0197349 A1
(43) Pub. Date: Jul. 1, 2021

(54) Compact Excavator & Skid Steer Loader Auxiliary Hydraulic Coupler Installer Tool

(71) Applicant: Steven Alan McDonald, Forestville, CA (US)

(72) Inventor: Steven Alan McDonald, Forestville, CA (US)

(21) Appl. No.: 16/727,318

(22) Filed: Dec. 26, 2019

(51) Int. Cl. B25B 27/02

(52) U.S. Cl. CPC B25B 27/02

(57) ABSTRACT

The ‘Compact Excavator & Skid Steer Loader Auxiliary Hydraulic Coupler Installer Tool’ is designed as a handheld tool for the purpose of mechanically installing high pressure auxiliary hydraulic attachment couplings on Compact Excavators & Skid Steer Loaders. The uniqueness of the tool is that it provides a safe, clean, fast and simple alternative to the use of hand wrenches, drip pans, rags and additional environmental cleanup materials that are required when attaching hydraulically driven auxiliary attachments to compact excavators and skid steer loaders. The tool consists of 4 basic components. The handle, anchor, attachment head and forcing head. The single anchor tool handle provides the base from which multiple tools can be configured to fit any attachment or machine application by using one of the 2 anchors and one of the 3 attachment heads with one of the 3 forcing heads.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE. OR A COMPUTER PROGRAM LISTING COMPACT DISC APPLICATION

Not Applicable.

### BACKGROUND OF INVENTION

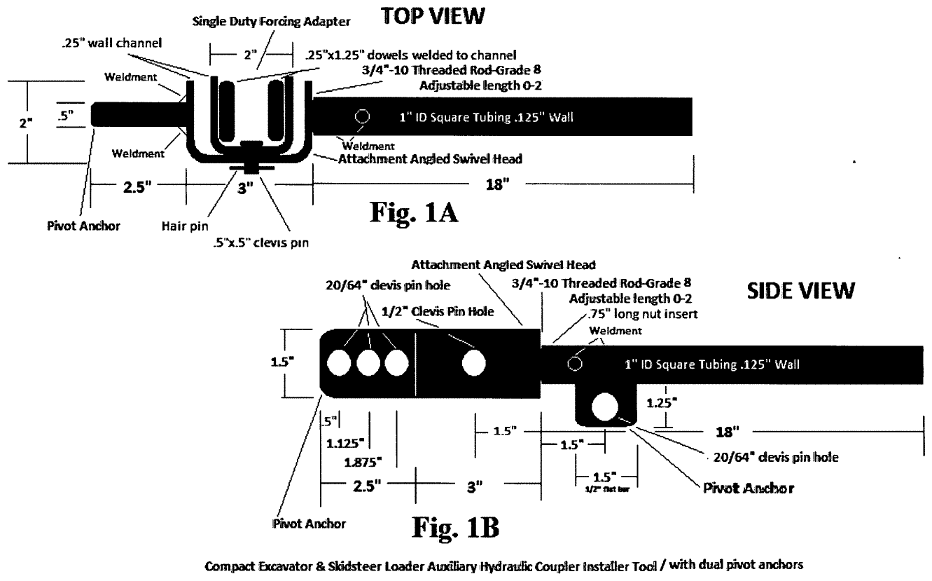

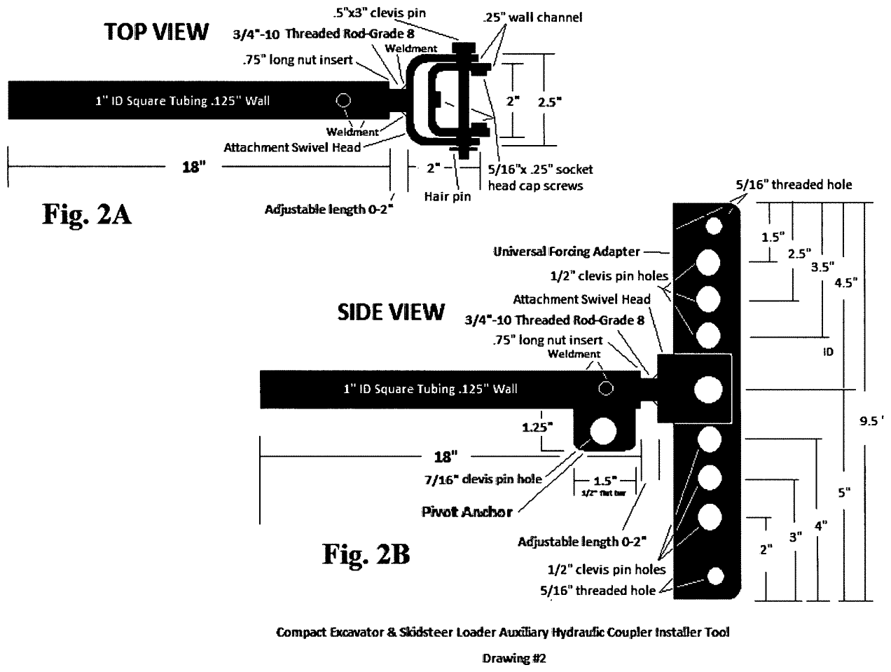

The ‘Compact Excavator & Skid Steer Loader Auxiliary Hydraulic Coupler Installer Tool’ (FIG. 1A-FIG. 1B and FIG. 2A-FIG. 2B) is designed as a handheld tool for the purpose of mechanically installing high pressure auxiliary hydraulic attachment couplings on Compact Excavators & Skid Steer Loaders. The purpose of the tool is to provide a clean, fast and simple alternative to the use of wrenches, drip pans, rags and additional environmental cleanup materials required when attaching hydraulically driven auxiliary attachments to Compact Excavators & Skid Steer Loaders.

### BRIEF SUMMARY OF INVENTION

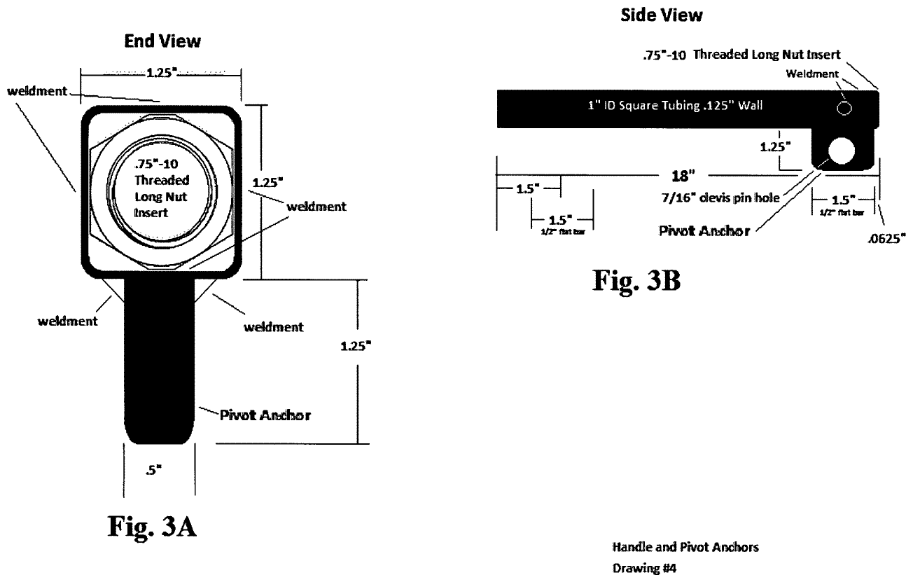

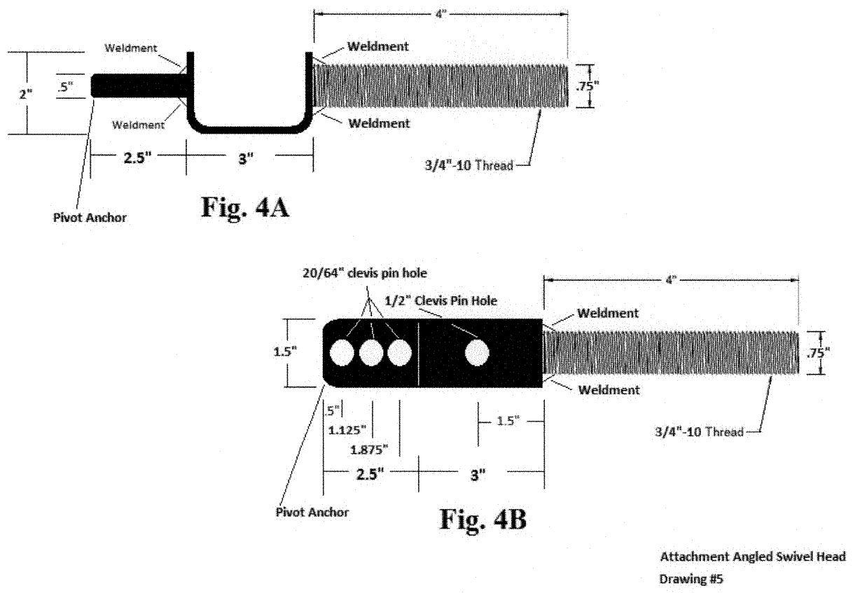

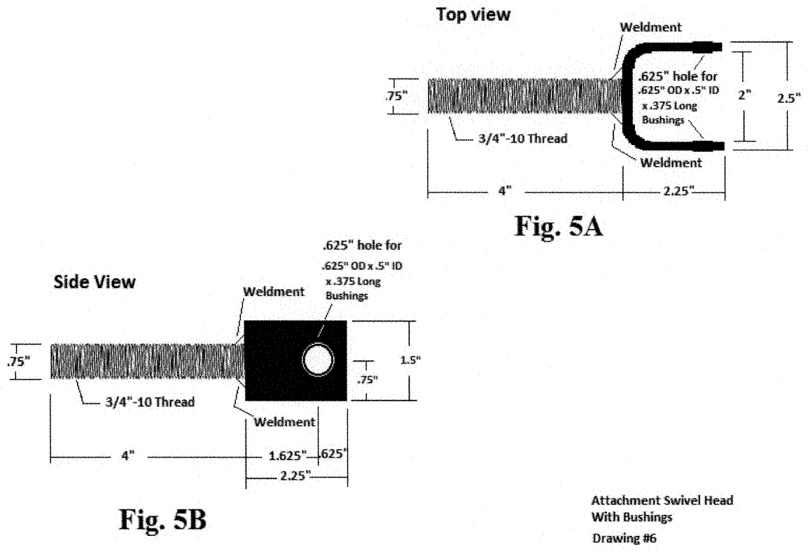

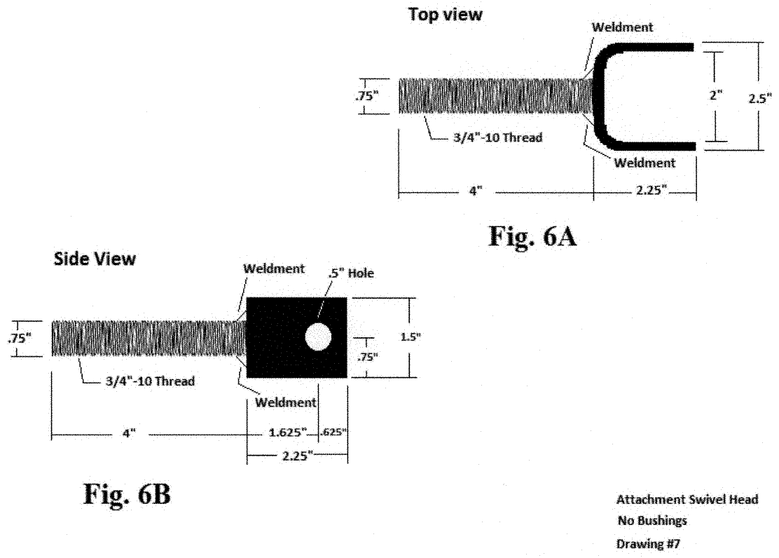

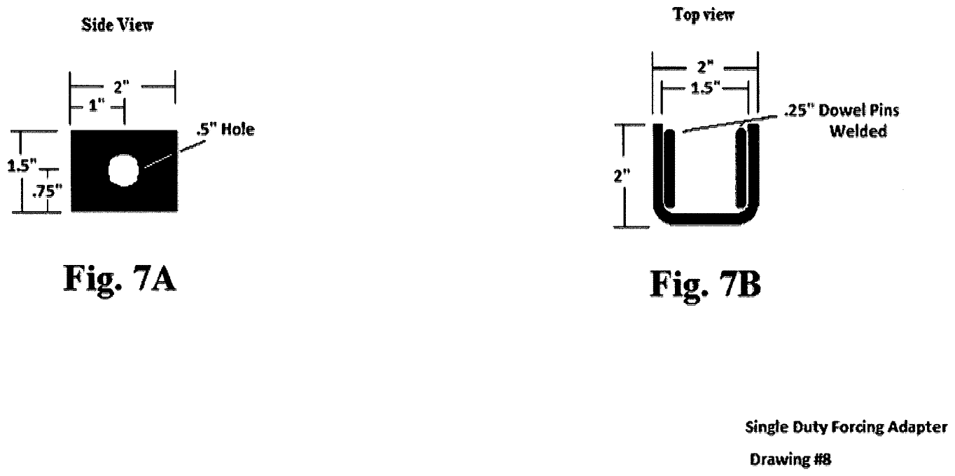

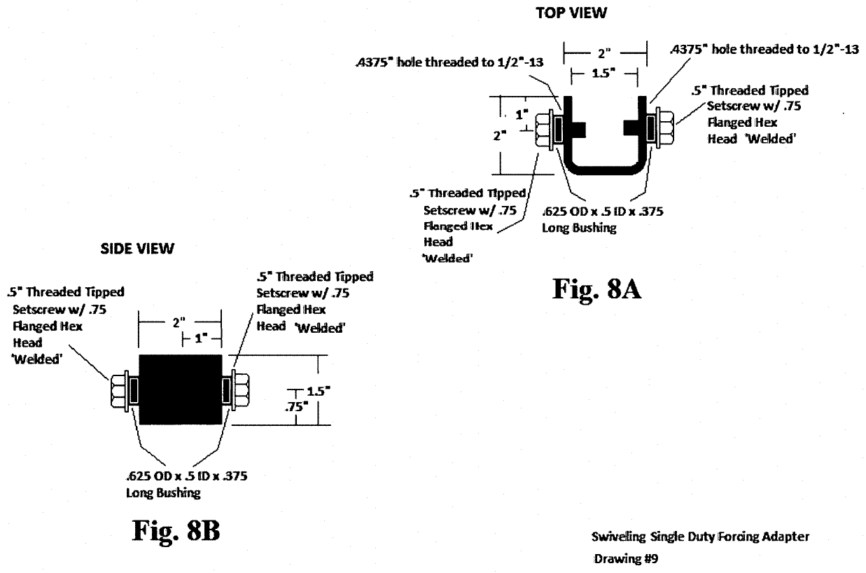

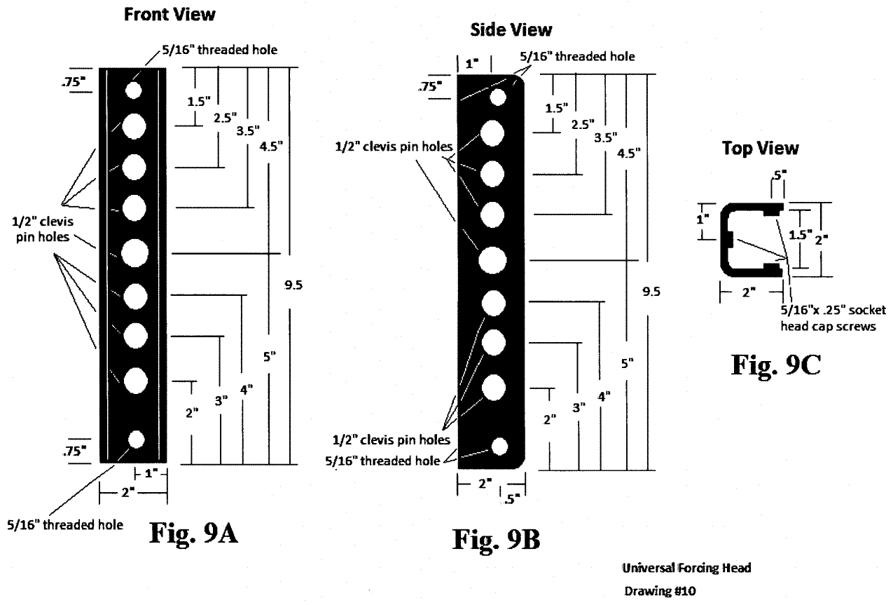

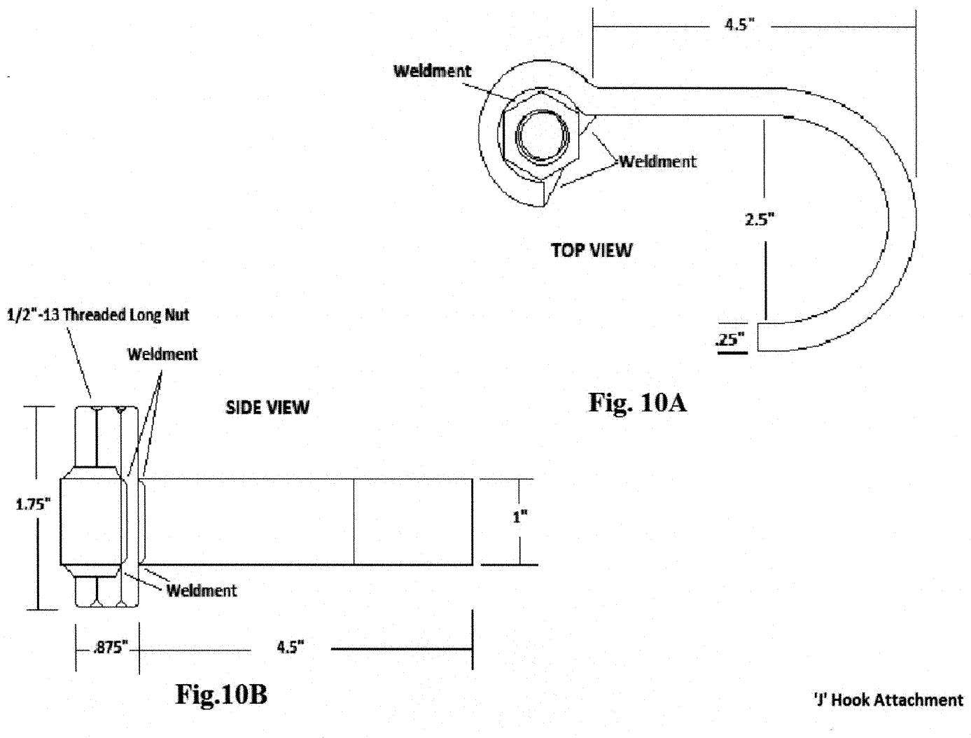

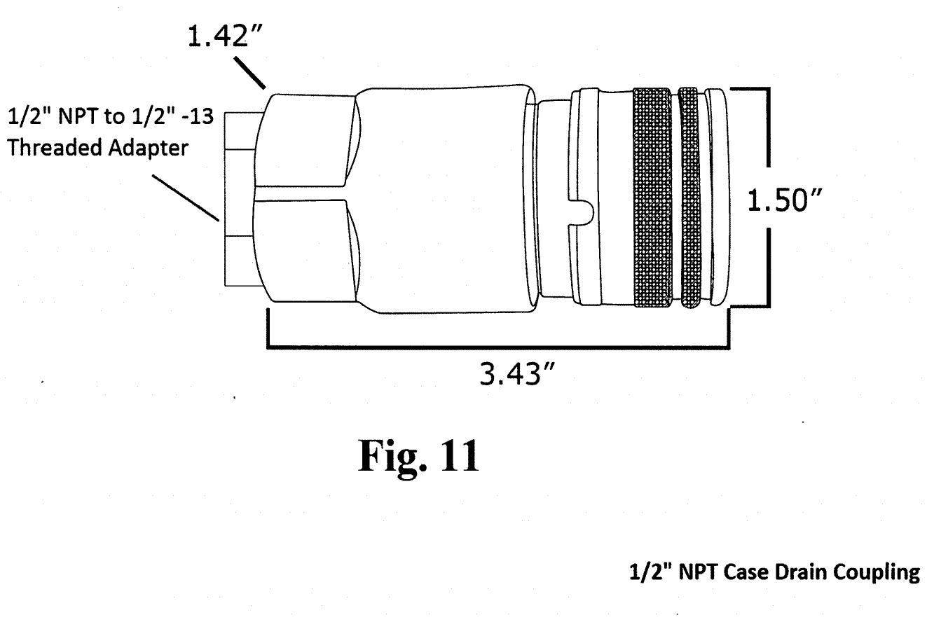

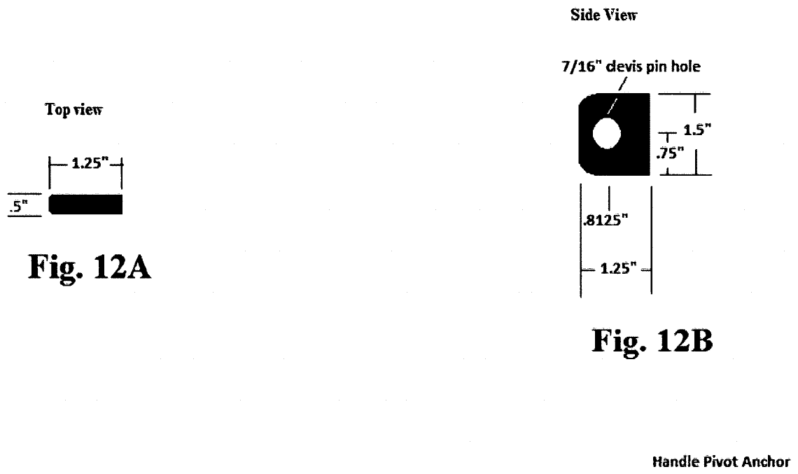

The tool consists of 4 base components that are able to be assembled into two different tools Tool′ (FIG. 1A-FIG. 1B and FIG. 2A-FIG. 2B). 1. The ‘Dual Pivot Anchor’ (FIG. 1A-FIG. 1B) tool. 2. The ‘Single Pivot Anchor’ (FIG. 2A-FIG. 2B) tool. The 4 base components are. 1. The ‘Handle’ (FIG. 3A-FIG. 3B) with an attachment pivot anchor (FIG. 12A—FIG. 12B) and a threaded swivel point (FIG. 3A-FIG. 3B). 2. The ‘Attachment Swivel Head’ that is available in three configurations to choose from (angled swivel head (FIG. 4A-FIG. 4B), swivel head with bushings (FIG. 5A-FIG. 5B) and swivel head without bushings (FIG. 6A-FIG. 6B)). 3. The ‘Forcing Head’ that is available in three configurations to choose from (single duty (FIG. 7A-FIG. 7B), swiveling single duty (FIG. 8A-FIG. 8B) and universal (FIG. 9A-FIG. 9B—FIG. 9C)). 4. The machine ‘Attachment’ that has two configurations to choose from (“J” hook (FIG. 10A-FIG. 10B) or coupling (FIG. 11)). These options allow the user to configure the tool to their specific application and needs. The interchangeable attachments are fully adjustable and interchangeable to provide a fit to any attachment, hydraulic coupler and compact excavator or skid steer loader applications.

The tool has the ability to be assembled in 3 different basic configurations and by simply adding attachments and/or forcing head options to the tool, the user has the ability to install every coupler available on the market made to be install on every compact excavator or skid steer loader on the market with any attachment desired.

### BRIEF DESCRIPTION OF THE SEVERAL VIEWS OF THE DRAWINGS

### Description of Figures

FIG. 1A-FIG. 1B—Assembled Tool Handle with the Attachment Angled Swivel Head and Single Duty Forcing Adapter. Drawing provides measurements for the assembled tool without the Anchoring Attachment. Drawing also provides locations of weldments, anchor pivot points, pivot pin and clevis pin hole sizes and locations as well as fabrication material descriptions. Drawing provides top view FIG. 1A and side view FIG. 1B of assembled tool Handle.

FIG. 2A-FIG. 2B—Assembled tool Handle with the Attachment Swivel Head and Universal Forcing Adapter. Drawing provides measurements for the assembled tool without the Anchoring Attachment. Drawing also provides locations of weldments, anchor pivot point, pivot pin and clevis pin hole sizes and locations as well as fabrication material descriptions. Drawing provides top view FIG. 2A and side view FIG. 2B of assembled tool Handle.

FIG. 3A-FIG. 3B—Handle and Pivot Anchor. Drawing provides measurements, locations of weldments, anchor pivot point, pivot pin hole size and location including size and location of the threaded insert in the one end of the handle as well as fabrication material descriptions. Drawing provides end view FIG. 3A and side view FIG. 3B of the tool Handle.

FIG. 4A-FIG. 4B—Attachment Angled Swivel Head. Drawing provides measurements, locations of weldments, anchor pivot points, pivot pin and clevis pin hole sizes and locations including the size and length of the threaded rod that threads into the handle threaded insert in drawing #4 as well as fabrication material descriptions. Drawing provides top view FIG. 4A and side view FIG. 4B of the Attachment Angled Swivel Head.

FIG. 5A-FIG. 5B—Attachment Swivel Head With Bushings. Drawing provides measurements, locations of weldments, bushing hole sizes and locations including the size and length of the threaded rod that threads into the handle threaded insert in FIG. 3A as well as fabrication material descriptions. Drawing provides top view FIG. 5A and side view FIG. 5B of the Attachment Swivel Head With Bushings.

FIG. 6A-FIG. 6B—Attachment Swivel Head Without Bushings. Drawing provides measurements, locations of weldments, hole size and locations including the size and length of the threaded rod that threads into the handle threaded insert in drawing #4 as well as fabrication material descriptions. Drawing provides top view FIG. 6A and side view FIG. 6B of the Attachment Swivel Head Without Bushings.

FIG. 7A-FIG. 7B—Single Duty Forcing Adapter. Drawing provides measurements, locations of weldments, hole size and location as well as fabrication material descriptions. Drawing provides side view FIG. 7A and top view FIG. 7B of the Single Duty Forcing Adapter.

FIG. 8A-FIG. 8B—Swiveling Single Duty Forcing Adapter. Drawing provides measurements, locations swivel bushings, setscrew s and threaded hole sizes and locations as well as fabrication material descriptions. Drawing provides top view FIG. 8A and side view FIG. 8B of the Swiveling Single Duty Forcing Adapter.

FIG. 9A-FIG. 9B-FIG. 9C—Universal Forcing Adapter. Drawing provides measurements, hole sizes and locations including threaded holes and sizes as well as fabrication material descriptions. Drawing provides front view FIG. 9A, side view FIG. 9B and top view FIG. 9C of the Universal Forcing Adapter.

FIG. 10A-FIG. 10B—‘J’ Hook Attachment. Drawing provides measurements, locations of weldments, threaded long nut size including the shape and size of the hook opening as well as fabrication material descriptions. Drawing provides top view FIG. 10A and side view FIG. 10B of the ‘J’ Hook Attachment.

FIGS. 11—½ Inch Case Drain Coupling. Drawing provides measurements of the coupling and size of the threaded adapter in one end. Drawing provides only one view of coupler.

FIG. 12A-FIG. 12B—Handle Pivot Anchor—Drawing provides measurements of the pivot anchor that is a fabricated sub-component part of the handle and is welded to one end of the handle in the manufacturing process as show in FIG. 3A-FIG. 3B. Drawing provides top view FIG. 12A and side view FIG. 12B.

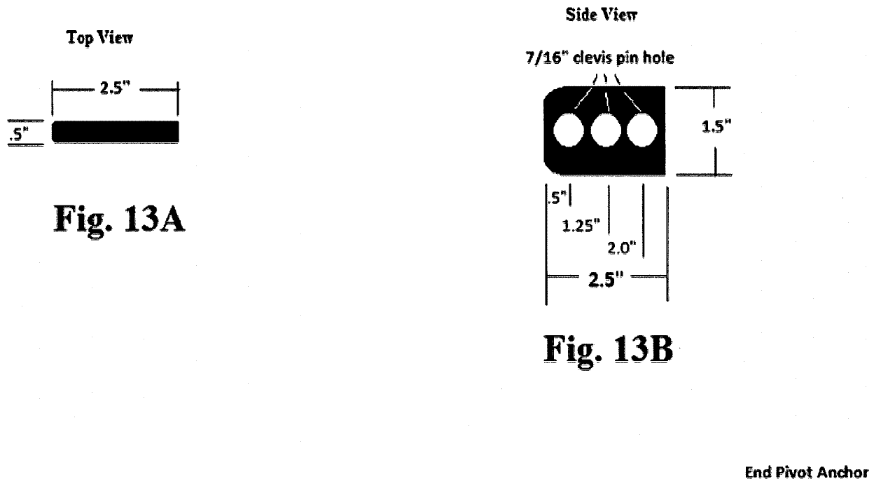

FIG. 13A-FIG. 13B—End Pivot Anchor—Drawing provides measurements of the end pivot anchor that is a fabricated sub-component part of the Attachment Angled Swivel Head and is welded to one end of the Attachment Angled Swivel Head in the manufacturing process as shown in FIG. 4A-FIG. 4B. Drawing provides top view FIG. 13A and side view FIG. 13B.

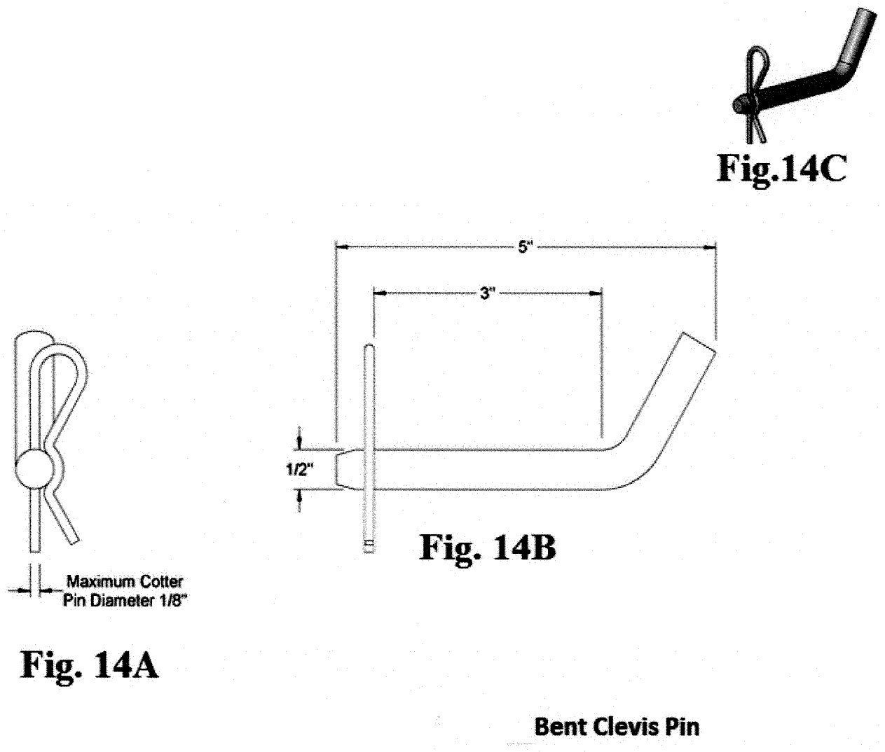

FIG. 14A, FIG. 14B-FIG. 14C—Bent-Pull Clevis Pin—Drawing provides measurements of the bent-pull clevis pin which is used in the final assembly of the tool to retain the Universal Forcing Head as shown in FIG. 2A-FIG. 2B and indicated as 0.5″×3″ Clevis Pin. Drawing provides end view FIG. 14A, side view FIG. 14B and pictorial view FIG. 14C.

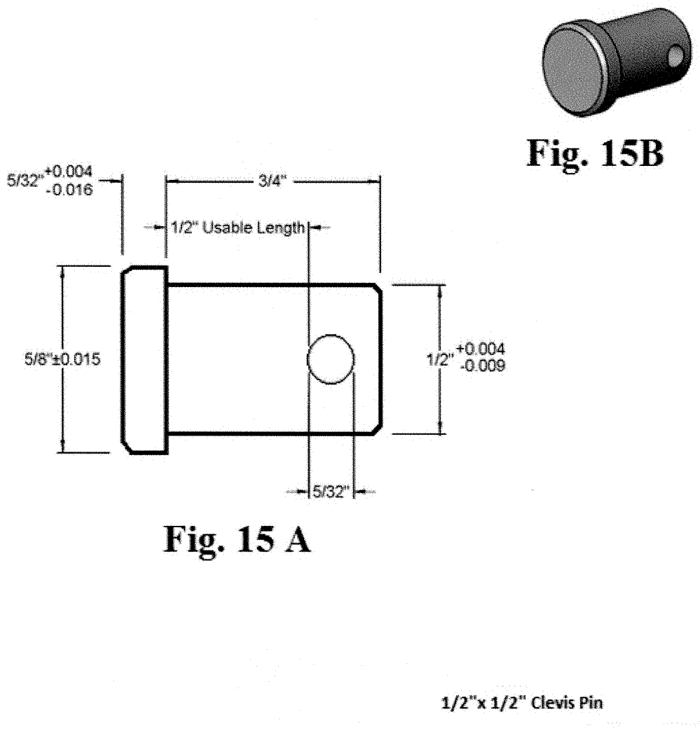

FIG. 15A-FIG. 15B—Clevis Pin—Drawing provides measurements of the ½″×½″ clevis pin which is used in the final assembly of the tool to retain the Forcing Head as shown in FIG. 1A-FIG. 1B and indicated as 0.5″×0.5″ Clevis Pin. Drawing provides side view FIG. 15A and pictorial view FIG. 15B.

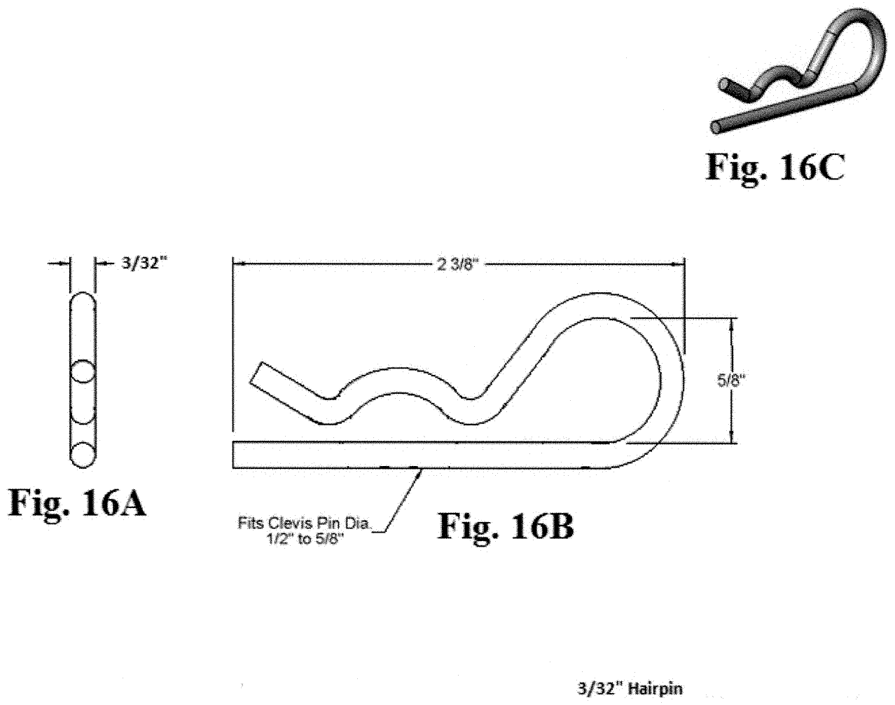

FIG. 16A-FIG. 16B-FIG. 16C—Hairpin—Drawing provides measurements of the hairpin which is used in the final assembly of the tool to retain all the clevis pins used on the tool as shown in FIG. 1A-FIG. 1B and FIG. 2A-FIG. 2B. Drawing provides end view FIG. 16A, side view FIG. 16B and pictorial view FIG. 16C.

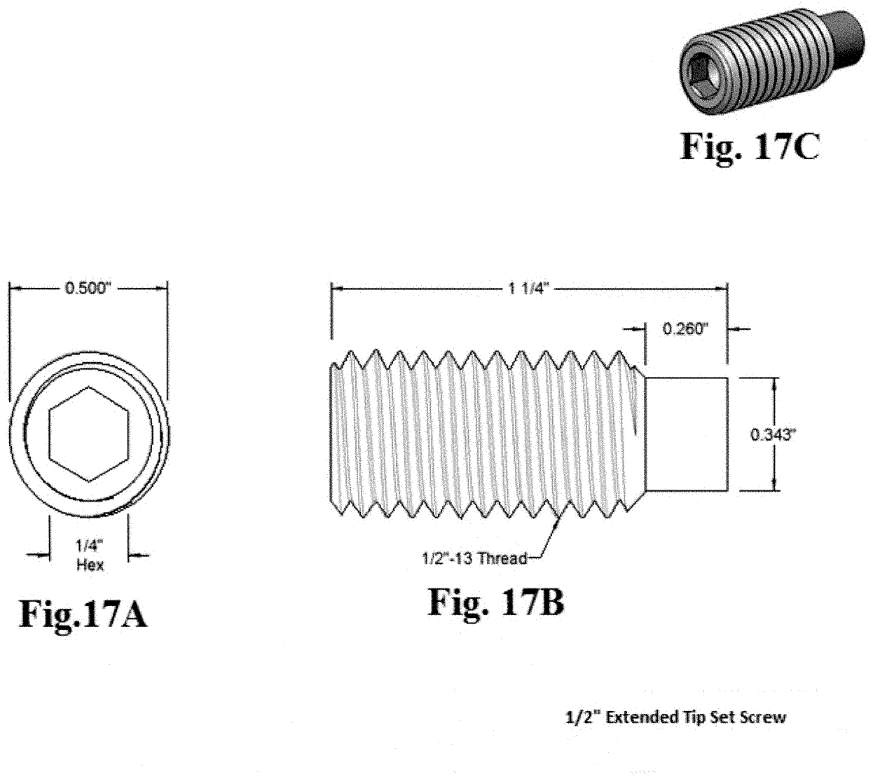

FIG. 17A, FIG. 17B-FIG. 17C—Setscrew—Drawing provides measurements of the extended tip setscrew that is a sub-component part of the Swiveling Single Duty Forcing Head and it is welded to the 0.5″ Flange Nut in the manufacturing process as shown in FIG. 8A-FIG. 8B. Drawing provides end view FIG. 17A, side view FIG. 17B and pictorial view FIG. 17C.

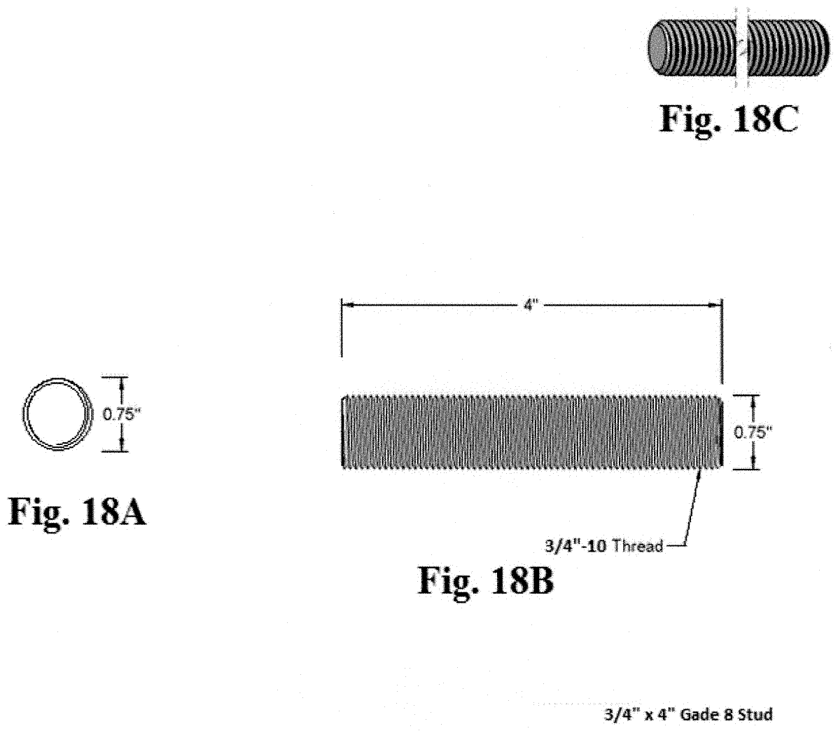

FIG. 18A, FIG. 18B-FIG. 18C—Stud—Drawing provides measurements of the ¾″×4″ grade 8 stud that is a sub-component part of the Attachment Swivel Heads and is welded to one end of each of the three Attachment Swivel Heads in the manufacturing process as shown in FIG. 4A-FIG. 4B/FIG. 5A-FIG. 5B/FIG. 6A-FIG. 6B. Drawing provides end view FIG. 18A, side view FIG. 18B and pictorial view FIG. 18C.

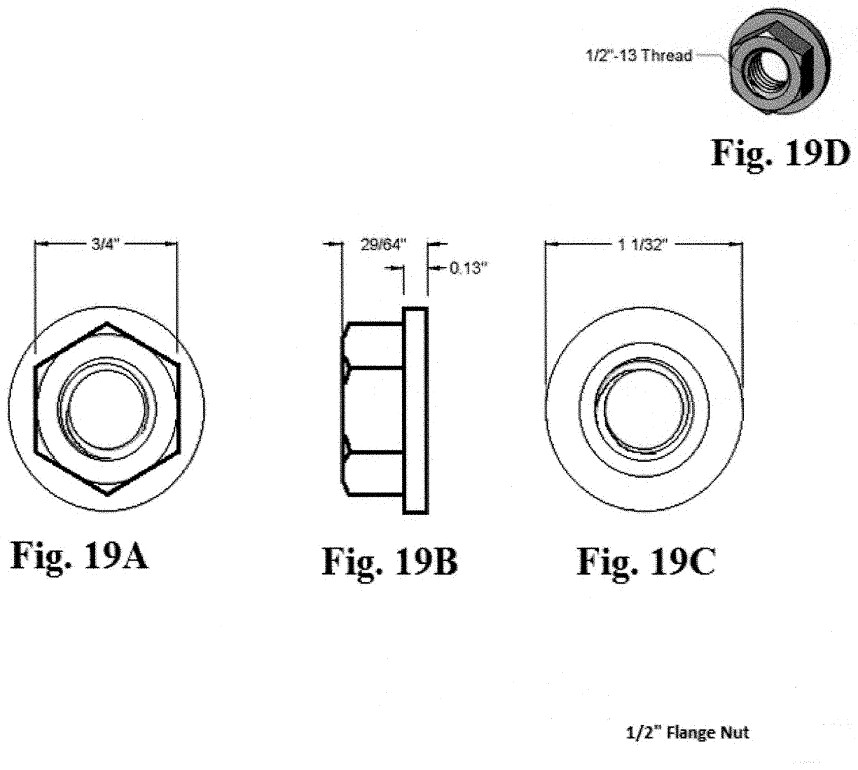

FIG. 19A-FIG. 19B-FIG. 19C-FIG. 19D—Flange Nut—Drawing provides measurements of the ½″ flange nut that is a sub-component part of the Swiveling Single Duty Forcing Head and is welded to the extended tip set screw in the manufacturing process as shown in FIG. 8A-FIG. 8B. Drawing provides front view FIG. 19A, side view FIG. 19B, back view FIG. 19C and pictorial view FIG. 19D.

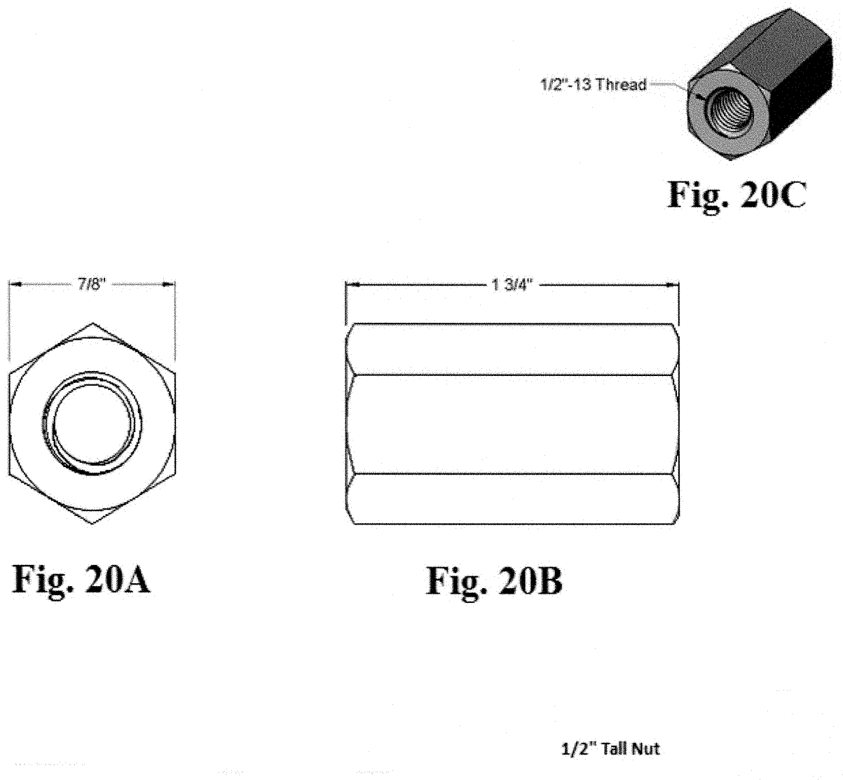

FIG. 20A-FIG. 20B-FIG. 20C—Tall Nut 1—Drawing provides measurements of the ½″ tall nut that is a sub-component part of the ‘J’ Hook Attachment and is welded to one end of the ‘J’ Hook Attachment in the manufacturing process as shown in FIG. 10A-FIG. 10B. Drawing provides end view FIG. 20A, side view FIG. 20B and pictorial view FIG. 20C.

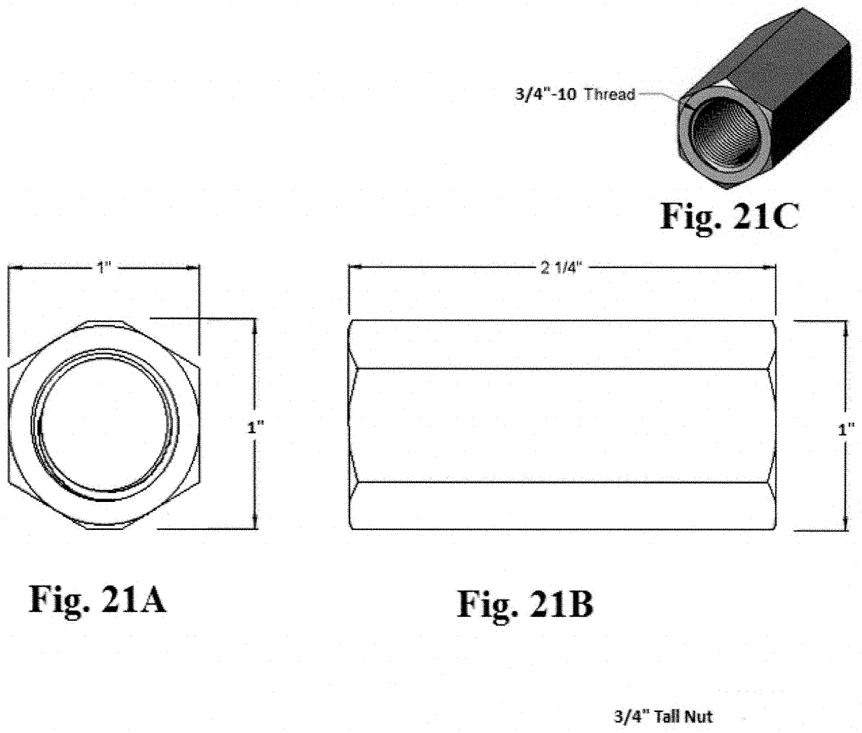

FIG. 21A-FIG. 218—FIG. 21C—Tall Nut 2—Drawing provides measurements of the ¾″ tall nut that is a sub-component part of the Handle and is plug welded inside one end of the Handle in the manufacturing process as shown in FIG. 3A-FIG. 3B. Drawing provides end view FIG. 21A, side view FIG. 21B and pictorial view FIG. 21C.

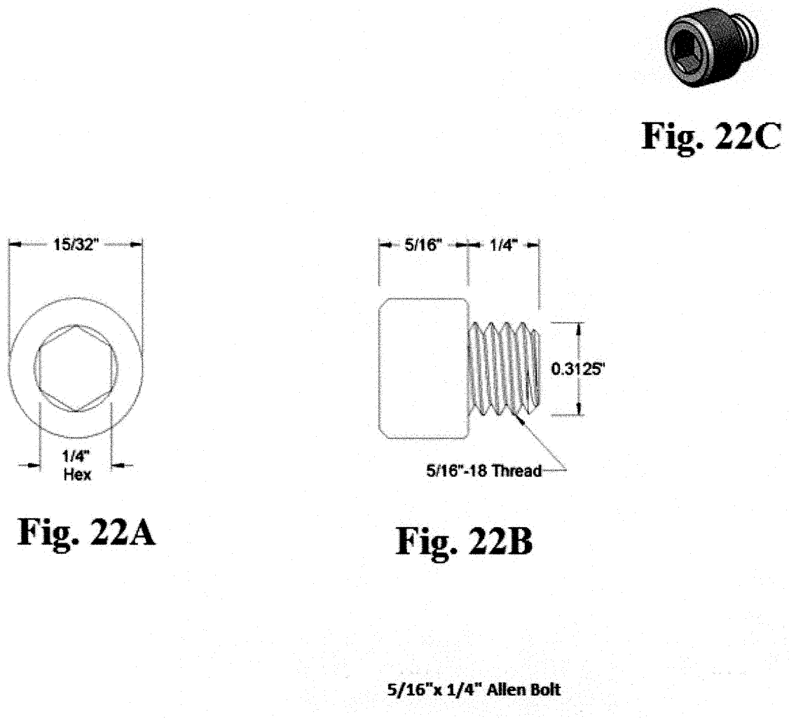

FIG. 22A-FIG. 22B-FIG. 22C—Allen Bolt—Drawing provides measurements of the 5/16″×¼″ Allen Head Bolts that are sub-component parts of the Universal Forcing Head and are threaded into drilled and tapped holes in both ends of the Universal Forcing Head in the manufacturing process as shown in FIG. 9A-FIG. 9B-FIG. 9C. Drawing provides end view FIG. 22A, side view FIG. 22B and pictorial view FIG. 22C.

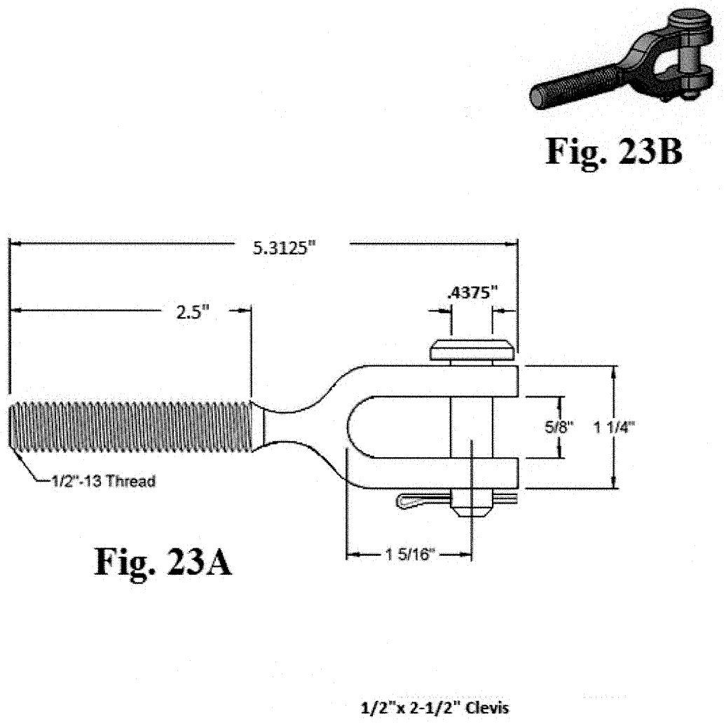

FIG. 23A-FIG. 23B—Clevis—Drawing provides measurements of the ½″×2½″ threaded clevis that is an attachment component part of the Case Drain Coupler that provides the connection between the Handle and Case Drain coupler by threading into the ½″ NPT to ½″-13 threaded adapter in the one end of the coupler in FIG. 11. Drawing provides side view FIG. 23A and pictorial view FIG. 23B.

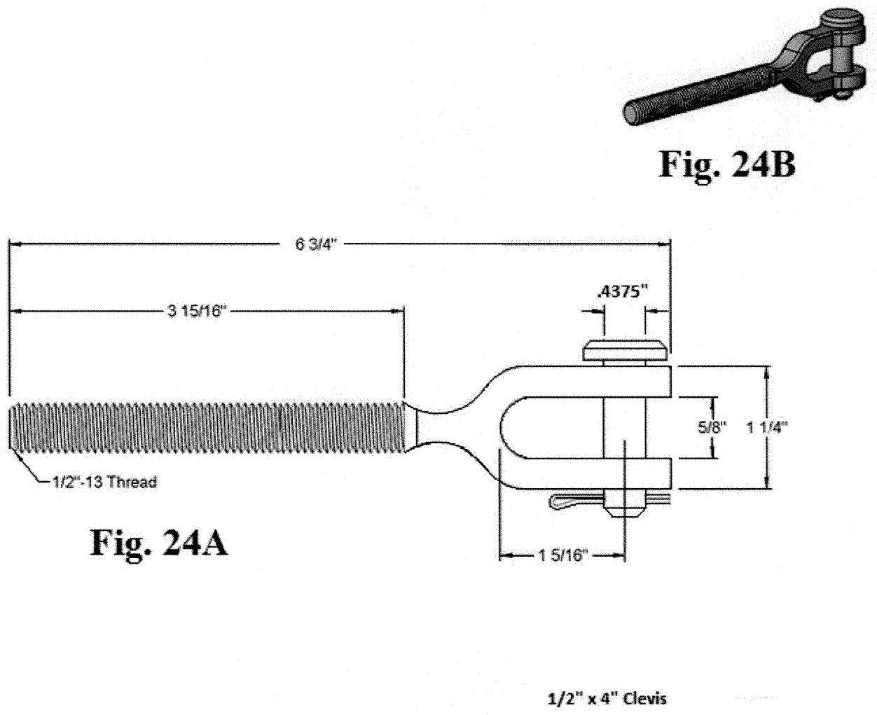

FIG. 24A-FIG. 24B—4″ Clevis—Drawing provides measurements of the ½″×4″ threaded clevis that is an attachment component part of the ‘J’ Hook Attachment that provides the connection between the Handle and ‘J’ Hook Attachment by threading into the ½″-13 tall nut in the one end of the ‘J’ Hook Attachment in FIG. 10A-FIG. 10B. Drawing provides side view FIG. 24A and pictorial view FIG. 24B.

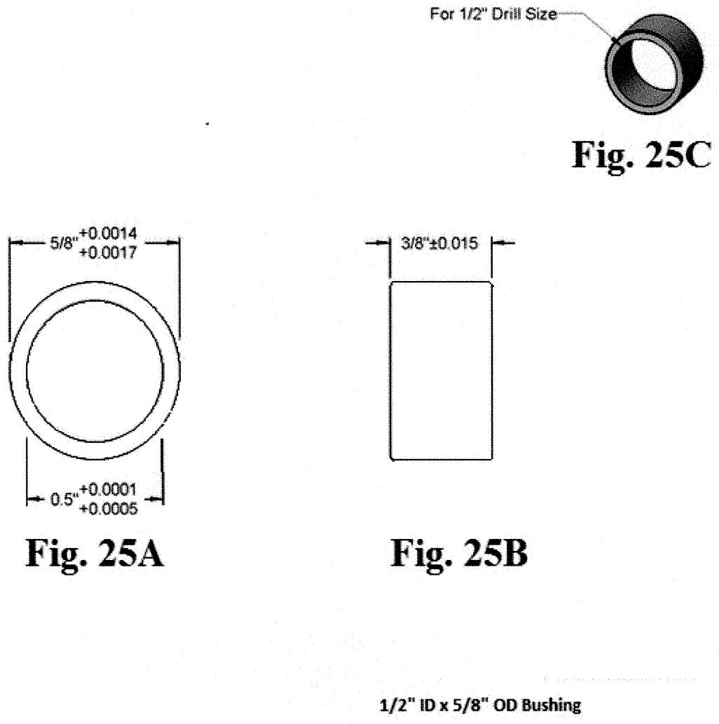

FIG. 25A-FIG. 25B-FIG. 25C—Bushing—Drawing provides measurements of the bushing that is a sub-component part of the Swiveling Single Duty Forcing Head and is assembled onto the Extended Tip Set screws on either side of the Swiveling Single Duty Forcing Head in the manufacturing process as shown in FIG. 8A-FIG. 8B. Drawing provides end view FIG. 25A, side view, FIG. 25B and pictorial view, FIG. 25C.

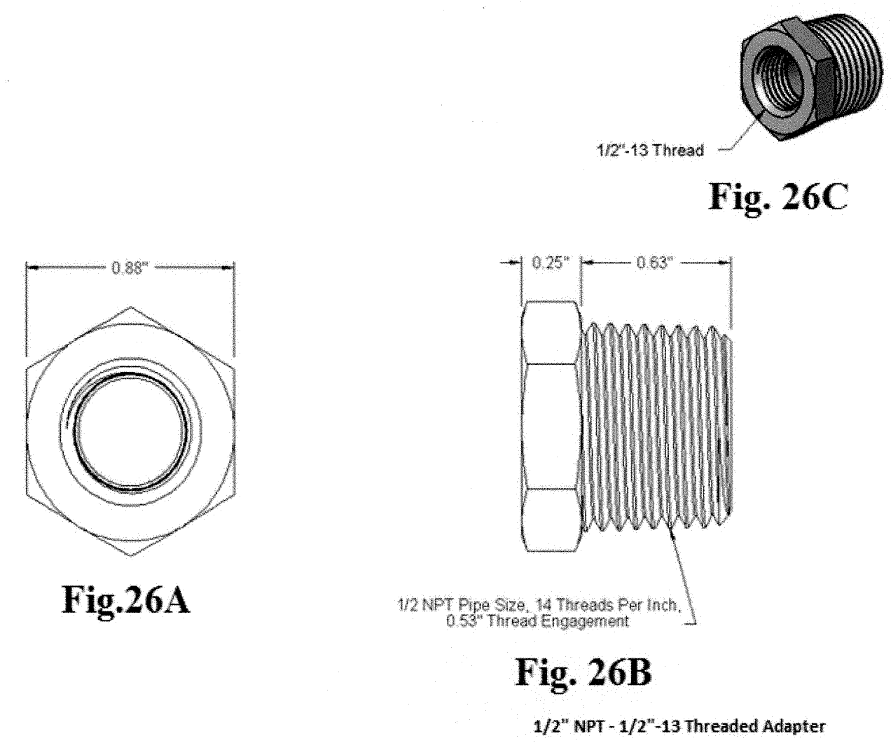

FIG. 26A-FIG. 26B-FIG. 26C—Threaded Adapter—Drawing provides measurements of the ½″ NPT to ½″-13 threaded adapter that is a component part of the Case Drain Coupler and is threaded into the Case Drain Coupler at one end as shown in Fig. Drawing provides end view FIG. 26A, side view FIG. 26B and pictorial view FIG. 26C.

The 18″ long ‘Handle’ FIG. 3A-FIG. 3B with its single pivot anchoring point and threaded swivel receptacle is the base that any tool option is configured from by installing or attaching two or more of the available components.

The ‘Pivot Anchor’ (FIG. 12A-FIG. 12B) is the portion of the tool handle (FIG. 1A-FIG. 1B) or pivot anchor (FIG. 13A—FIG. 13B) of the swivel head (FIG. 4A-FIG. 4B) where the ‘Attachment Anchor’ (“J” hook (FIG. 10A-FIG. 10B)) or coupling (FIG. 11) is attached to the tool. The ‘Pivot Anchor’ (FIG. 12A-FIG. 12B) or (FIG. 13A-FIG. 13B) provides a point which the handle/lever will pivot when leverage is applied.

The ‘Attachment Anchor’ (“J” hook (FIG. 10A-FIG. 10B)) or coupling (FIG. 11) is attached to the handle at the ‘Pivot Anchor’ point at one end and to the machine at that other end. Either by hooking the ‘J’ Hook (FIG. 10A-FIG. 10B) behind the machine coupler bulkhead or by coupling the ‘½″ Coupler’ (FIG. 11) to the case drain coupling on the machine. This provides a solid base to which leverage can be applied when forcing the hydraulic coupler into place.

The ‘Attachment Swivel Head’ (FIG. 4A-FIG. 4B/FIG. 5A-FIG. 5B/FIG. 6A-FIG. 6B) are threaded into the end of the handle and are adjustable from 0″ to 2″. This provides an attachment point for the coupler ‘Forcing Head’ (FIG. 7A—FIG. 7B/FIG. 8A-FIG. 8B/FIG. 9A-FIG. 9B). The 3 designs allow the tool to be adapted to fit both Compact Excavators & Skid Steer Loaders of all make and models.

The ‘Forcing Heads’ (FIG. 7A-FIG. 7B/FIG. 8A-FIG. 8B/FIG. 9A-FIG. 9B) are held in place on the ‘Attachment Swivel Head’ (FIG. 4A-FIG. 4B) by use of a clevis pin (FIG. 15A-FIG. 15B) and hairpin (FIG. 16A-FIG. 16B-FIG. 16C) or the head swivel setscrews (FIG. 17A-FIG. 17B-FIG. 17C). The ‘Universal Forcing Head’ FIG. 9A-FIG. 9B-FIG. 9C is interchangeable to any of the three ‘Attachment Swivel Heads’ (FIG. 4A-FIG. 4B/FIG. 5A-FIG. 5B/FIG. 6A-FIG. 6B) and this combination of components provides the means of retaining the hydraulic coupling to be installed when leverage is applied to the handle.

### DETAILED DESCRIPTION OF THE INVENTION

### Compact Excavator & Skid Steer Loader Auxiliary Hydraulic Coupler Installer Tool Manufacture, Assembly Process and Use of Tool

Step 1. Cut materials to lengths as follows:
a. 0.5″×1.5″ flat bar to 1.25″ length for ‘Handle Pivot Anchor’ (FIG. 12A-FIG. 12B).
b. 0.5″×1.5″ flat bar to 2.25″ length for ‘End Pivot Anchor’ (FIG. 13A-FIG. 13B).
c. 1″×1″ ID square tubing to 18″ length for ‘Tool Handle’ (FIG. 3A-FIG. 3B),
d. 4″×3″×0.25″ wall square tubing to 1.5″ length for ‘Attachment Angled Swivel Head’ (FIG. 4A-FIG. 4B), 1. Cut 4″ length of tube at 2″ to create (2) 2″×3″×1.5″ “U” channels.
e. 2.5″×2.5″×0.25″ wall square tubing to 1.5″ length for ‘Attachment Swivel Head With and Without Bushings’ (FIG. 5A-FIG. 5B & FIG. 6A-FIG. 6B),
   1. Cut seam side of tubing off the create 2.5″×2.25″×1.5″’ Attachment Swivel Head (FIG. 5A-FIG. 5B & FIG. 6A, FIG. 6B),
f. Remove hex head of ¾″-10×4″ grade 8 bolt to create stud ¾″-10×4″ (FIG. 18A-FIG. 18B-FIG. 18C),
g. 4″×2″×0.25″ wall square tubing to 1.5″ length for ‘Single Duty Forcing Head’ (FIG. 7A-FIG. 7B) or ‘Swiveling Single Duty Forcing Head’ (FIG. 8A-FIG. 8B).
   1. Cut 4″ length of tube at 2″ to create (2) 2″×2″×1.5″ “U” channel Forcing Heads in (FIG. 7A-FIG. 7B & FIG. 8A-FIG. 8B).
h. 4″×2″×0.25″ wall square tubing to 9.5″ length for ‘Universal Forcing Adapter’ (FIG. #9).
   1. Cut 4″ length of tube at 2″ to create (2) 2″×2″×9.5″ “U” channel for ‘Universal Forcing Adapter’ (FIG. 9A-FIG. 9B-FIG. 9C),
i. 0.25″ round stock to 1.25″ for ‘Welded Dowel Pins’ in ‘Single Duty Forcing Head’ (FIG. 7A-FIG. 7B).
j. 1″×0.25″ flat bar to 11″ length for hook of ‘ “J” Hook Attachment’ (FIG. 10A-FIG. 10B).
   Step 2. Prep. materials for assembly and welding:
a. Grind 2 opposing pinnacles from ¾″-10 tall nut (FIG. 21A-FIG. 21B-FIG. 21C).
b. Deburr and grind all corners of cut materials to rounded corners and edges in preparation for welding.
c. Locate, center punch and drill 0.4375″ hole at 0.75″×0.8125″ in 0.5″×1.5″×1.25″ flat bar for “Handle Pivot Anchor” from Step 1 (a) (FIG. 12A-FIG. 12B).
d. Locate, center punch and drill (3) 0.4375″ holes at 0.75″×0.5″ at 0.75×1.125″ at 0.75″×1.75″ in 0.5″×1.5″ ×2.25″ flat bar for ‘End Pivot Anchor’ from Step 1 (b) (FIG. 13A-FIG. 13B).
e. Locate, center punch and drill (4) 0.375″ holes (holes are on opposing sides) (2) at 0.75″ (top and bottom) and (2) at 1.5″ (each side) of 1″×1″×18″ long square tubing ‘Tool Handle’ from Step 1 (c) to provide weld mounting of ¾″-10 tall nut (FIG. 21A-FIG. 21B-FIG. 21C) inside ‘Tool Handle’ (FIG. 13A-FIG. 13B).
f. Locate, center punch and drill 0.5 hole at 0.75″×1.5″ in the 3″ side (bottom) of the 2″×3″×15.″×0.25″ wall “U” channel from Step 1 (d)(1) (FIG. 4A-FIG. 4B),
g. Locate, center punch and drill (2) 0.5″ holes in opposing sides of 2.5″×2.25″×1.5″ “U” channel from Step 1 (e)(1) at 0.625″×0.75″ for ‘Attachment Swivel Head with no Bushings’ (FIG. 6A-FIG. 6B).
   1. Locate, center punch and drill (2) 0.625″ holes in 2.5″×2.25″×1.5″ “U” channel from Step 1 (e)(1) in the same locations for ‘Attachment Swivel Head with Bushings’ (FIG. 5A-FIG. 5B).
h. Locate, center punch and drill 0.5 hole at 0.75″×1.0″ in the 2″ side (bottom) of the 2″×2″×15.″×0.25″ wall “U” channel from Step 1 (g)(1) for ‘Single Duty Forcing Head’ (FIG. 7A-FIG. 7B).
   1. Locate, center punch and drill (2) 0.4375 holes in opposing sides of “U” channel from Step 1 (g)(1) at 0.625″×0.75″ and thread holes to ½″-13 for ‘Swiveling Single Duty Forcing Head’ (FIG. 8A-FIG. 8B).
i. Locate, center punch and drill (7) 0.5 holes (holes in opposing sides as follows) at 1″×2″ at 1″×3″ at 1″×4″ at 1″×5″ at 1″×6″ at 1″×7″ at 1″×8″ of the 2″×2″×9.5″×0.25″ wall “U” channel from Step
   1 (h)(1) (FIG. 9A-FIG. 9B-FIG. 9C).
j. Locate, center punch and drill (4) 0.25 holes (holes in opposing sides as follows) at 0.75″×0.5″ from open face of “U” channel on both of the 2″×2″×9.5″×0.25″ wall “U” channel from Step 1 (h)(1). Thread these 4 holes to 5/16″-18 (FIG. 9A-FIG. 9B-FIG. 9C).
k. Locate, center punch and drill (2) 0.25 holes (holes in bottom of “U” channel as follows) at 1″ center×0.75″ from bottom and top of “U” channel on 2″×2″×9.5″×0.25″ wall “U” channel from Step 1 (h)(1). Thread these 2 holes to 5/16″-18 (FIG. 9A-FIG. 9B-FIG. 9C).
l. Locate, center punch and drill (7) 0.5 holes (holes in bottom of “U” channel as follows) at 1″×2″ at 1″×3″ at 1″×4″ at 1″×5″ at 1″×6″ at 1″×7″ at 1″×8″ of the 2″×2″×9.5″×0.25″ wall “U” channel from Step 1 (h)(1) (FIG. 9A-FIG. 9B-FIG. 9C).
m. Bend one end of the 1″×0.25″×11″ flat bar (step 1(j)) into a 2.5″ wide “J” hook (FIG. 10A-FIG. 10B). Leaving a 6″ long end to be shaped for the installation and welding of the ½″-13 tall nut (FIG. 20A—FIG. 20B-FIG. 20C).
   1. Bend opposite end of ‘J’ Hook (FIG. #10) 45 degrees away from open end of hook and then into a ⅞″ opening circle toward the hook to receive the ½″-13 tall nut (FIG. 20A-FIG. 20B-FIG. 20C).
n. After all components have been cut and drilled and shaped. Deburr and grind smooth.
   Step 3. Assembly and welding of ‘Handle’ components: (FIG. 3A-FIG. 3B).
a. Install ¾″-10 tall nut (FIG. 21A-FIG. 21B-FIG. 21C) into 1″ square tubing at end with (4) 0.375 drilled holes in Step 2 (e) to a depth of 0.25″ below the face of the tube and plug weld all 4 predrilled holes to the inserted tall nut (FIG. 21A-FIG. 21B-FIG. 21C).
b. Locate “Handle Pivot Anchor” from Step 2 (c) (FIG. 12A-FIG. 12B) on center line of handle (FIG. 3A—FIG. 3B) at tall nut (FIG. 21A-FIG. 21B-FIG. 21C) end and 0.0625″ back from face of the tube and weld on both sides of the anchor (FIG. 12A-FIG. 12B) parallel to the handle length. c. Let cool and chase tall nut (FIG. 21A-FIG. 21B-FIG. 21C) threads.
   Step 4. Assembly and welding of ‘Attachment Angled Swivel Head’: (FIG. 4A-FIG. 4B)
a. On the opposite ends of the 2″×3″×15.″×0.25″ wall “U” channel from Step 2 (f). Locate center on both 2″×1.5″ ends.
b. Center and weld the ¾″-10 grade 8 stud (FIG. 18A-FIG. 18B-FIG. 18C) from Step 1 (f) to one of the 2″×1.5″ ends of the “U” channel.
c. Center and weld ‘End Pivot Anchor’ (FIG. 13A-FIG. 13B) from Step 2 (d) parallel to the 3″ opening of the opposite 2″×1.5″ end of the “U” channel from the ¾″-10 grade 8 stud (FIG. 18A-FIG. 18B-FIG. 18C) end from Step 4 (b).
   Step 5. Assembly and welding of ‘Attachment Swivel Head’: (No Bushing (FIG. 6A-FIG. 6B) and With Bushing (FIG. 5A-FIG. 5B).
a. Center and weld the ¾″-10 grade 8 stud (FIG. 18A-FIG. 18B-FIG. 18C) from Step 1 (f) to outside bottom end of 2.5″×2.25″×1.5″ “U” channel from Step 2 (g) for No Bushing (FIG. 6A-FIG. 6B).
b. Center and weld the ¾″-10 grade 8 stud (FIG. 18A-FIG. 18B-FIG. 18C) from Step 1 (f) to outside bottom end of 2.5″×2.25″×1.5″ “U” channel from Step 2 (g)(1) for With Bushing (FIG. 5A-FIG. 5B).
   Step 6. Assembly and welding of the ‘Single Duty Forcing Head’: (FIG. 7A-FIG. 7B)
a. Locate center on the opposing sides of the 2″×2″×15.″×0.25″ wall “U” channel from Step 2 (h).
b. Clamp 0.25″×1.25″ dowel pins from Step 1 (i) to both inside legs of the “U” channel on centerlines and tack weld in 2 places on one side of each of the dowel pins.

### Step 7. Assembly of the ‘Swiveling Single Duty Forcing Head’: (FIG. 8A-FIG. 8B)

a. On the 2″×2″×15.″×0.25″ wall “U” channel from Step 2 (h)(1) assemble ½″-13 long tip set screw (FIG. #17), 0.5″×ID>0.625″ OD>0.375″ long bushing (FIG. 25A-FIG. 25B-FIG. 25C) and ½″-13 flange nut (FIG. 19A-FIG. 19B-FIG. 19C-FIG. 19D) into threaded holes and tighten flange nut (FIG. 19A-FIG. 19B-FIG. 19C-FIG. 19D) flush with set screw head (FIG. 17A-FIG. 17B-FIG. 17C).
b. Weld set screw head (FIG. 17A-FIG. 17B-FIG. 17C) to flange nut (FIG. 19A-FIG. 19B-FIG. 19C-FIG. 19D).
c. Repeat process for opposite side.

### Step 8. Assembly of the ‘Universal Forcing Adapter’: (FIG. 9A-FIG. 9B-FIG. 9C).

a. Thread all (6) of the 0.25″ drilled holes at both ends of the 9.5″ long “U” channel from Step 2(j) and Step 2(k) to 5/16″-18 thread.
b. Insert (6) 5/16″-18×0.25″ Allen bolts (FIG. 22A-FIG. 22B-FIG. 22C) with thread lock and tighten.
   Step 9. Assembly and welding of the ‘ “J” Hook Attachment’: (FIG. 10A-FIG. 10B)
a. Insert ½″-13 threaded tall nut (FIG. 20A-FIG. 20B-FIG. 20C) into the ⅞″ opening created in Step 2 (l)(1) and weld both inside portions of ⅞″ opening.
b. Let cool and chase ½″-13 threads in tall nut (FIG. 20A-FIG. 20B-FIG. 20C).
c. Thread 4″ threaded clevis (FIG. 24A-FIG. 24B) into “J” hook tall nut (FIG. 20A-FIG. 20B-FIG. 20C).

### Step 10. Assembly of ‘Case Drain Coupling Anchor’: (FIG. 11).

a. Thread ½″ NPT to ½″-13 adapter (FIG. 26A-FIG. 26B-FIG. 26C) into ½″ case drain coupling (FIG. 11).
b. Thread 2.5″ threaded clevis (FIG. 23A-FIG. 23B) into coupling adapter (FIG. 26A-FIG. 26B-FIG. 26C).

### Assembly and Use of the Tool

To assemble the tool for use with the ‘Angled Swivel Head’ as drawn in (FIG. 1A-FIG. 1B) simply choose the forcing adapter (FIG. 7A-FIG. 78 or FIG. 9A-FIG. 9B-FIG. 9C) for the application and install it in the ‘Attachment Angled Swivel Head’ (FIG. 4A-FIG. 4B) using the ½″×½″ clevis pin (FIG. 15A-FIG. 15B) and hairpin (FIG. 16A-FIG. 16B-FIG. 16C). Then choose the anchor for the application (either the ‘Case Drain Coupling (FIG. 11) Anchor’ or the ‘ “J” Hook Attachment’ (FIG. 10A-FIG. 10B) Anchor and install it on either the ‘End Pivot Anchor’ in (FIG. 4A-FIG. 4B) or the ‘Handle Pivot Anchor’ in (FIG. 3A-FIG. 3B) using the 7/16″ clevis pin in (FIG. 23A-FIG. 23B or FIG. 24A-FIG. 24B). and hairpin (FIG. 16A-FIG. 16B-FIG. 16C).

To assemble the tool for use with the ‘Swivel Head No Bushing’ (FIG. 6A-FIG. 6B) or ‘Swivel Head with Bushings’ (FIG. 5A-FIG. 5B) simply choose the forcing adapter (FIG. 7A-FIG. 7B, FIG. 8A-FIG. 88 or FIG. 9A-FIG. 9B-FIG. 9C) for the application and install it in the corresponding ‘Attachment Swivel Head’ (FIG. 6A-FIG. 6B or FIG. 5A-FIG. 5B) using the ½″×3″ clevis pin (FIG. 15A-FIG. 15B) and hairpin (FIG. 16A-FIG. 16B-FIG. 16C) or threaded setscrews and bushings (FIG. 8A-FIG. 8B). Then choose the anchor for the application (either the ‘Case Drain Coupling Anchor’ (FIG. 11) or the ′“J” Hook Attachment′ (FIG. 10A-FIG. 10B)) and install it on the ‘Handle Pivot Anchor’ (FIG. 3A-FIG. 3B) using the 7/16″ clevis pin in (FIG. 23A-FIG. 23B or FIG. 24A-FIG. 24B) and hairpin (FIG. 16A-FIG. 16B-FIG. 16C).

To Install the tool on the machine simply choose the appropriate ‘Anchor Attachment’ for the application. For the ‘ “J” Hook Attachment’ (FIG. 10A-FIG. 10B) place the hook over the auxiliary lines behind their mounting bracket on the machine and adjust as needed. For the ‘Case Drain Coupling Anchor’ (FIG. 11). First determine whether the handle pivot in (FIG. 3A-FIG. 3B) or the end pivot in (FIG. 4A-FIG. 4B) are appropriate and pin the anchor to the appropriate pivot point. Next couple the anchor coupling (FIG. 11) to the auxiliary case drain coupling on the machine and adjust as needed.

Once the tool is in place adjustments can be made by extending the Attachment Angled Swivel Head (FIG. #4) or moving the Anchor Attachment on the End Pivot Anchor (FIG. #4). Additional adjustments can be made by screwing the Anchor Attachment (‘J’ Hook (FIG. 10A-FIG. 10B) or ‘Case Drain Coupler (FIG. 11)) on or off the threaded clevis (FIG. 23A-FIG. 23B or FIG. 24A-FIG. 24B).

Once the tool has been adjusted and attached to the machine. Place the auxiliary hydraulic attachment coupler in the ‘Forcing Head’ (FIG. 7A-FIG. 7B/FIG. 8A-FIG. 8B or FIG. 9A-FIG. 9B-FIG. 9C) and align the coupler with the mating hydraulic coupler on the machine. Push or pull on the tool handle (depending on the application) to push the auxiliary hydraulic attachment coupling towards the machine hydraulic coupling until it snaps into place. Once the hydraulic coupling is in place, rotate the female coupling collar to lock the hydraulic couplings together.

Remove and store the tool or reset and reconfigure the tool for the next hydraulic coupler to be installed.

1. I, ‘Steven Alan McDonald’, am the sole inventor and creator of the ‘Compact Excavator & Skid Steer Loader Auxiliary Hydraulic Coupler Installer Tool’.
The concept for the tool came out of complaints from customers, operators, mechanics and my own experience in changing out hydraulic equipment attachments on compact excavators and skid steer loaders. The normal process for this often requires the use two wrenches to break free the machine and/or attachment hydraulic coupler lines to bleed off hydraulic oil pressure so the hydraulic attachment couplings can be coupled together. This process is often hazardous, time consuming and messy as hydraulic oil leaks from the lines when they are loosened to relieve the hydraulic pressure on the couplings. This process of loosening the lines creates the potential for two problems. First is a safety issue. When loosening high pressure hydraulic oil lines, the escaping hydraulic fluid under pressure can cause serious injury and second is the environmental hazard as the leaking hydraulic fluid often ends up on the ground rather than in a catch basin.
I began the process of development on the tool on Oct. 11, 2019 and by Dec. 1, 2019 I had the first working all in one prototype which worked but was cumbersome to use.
During development the design changed from an all in one tool to a basic tool handle that can be modified to fit all applications by changing attachments, anchors or forcing heads. This allows the user to adapt the tool to their specific needs while making the tool compact enough for storage on most machines or in tool boxes.
The tool completely eliminates the need to break free coupler hydraulic oil lines to bleed off hydraulic pressure and thus eliminating the safety hazards and environmental hazards of hot, high pressure leaking oil.
